(19) United States
(12) Patent Application Publication
(10) Pub. No.: US 2017/0248917 A1
(43) Pub. Date: Aug. 31, 2017

(54) SYSTEM FOR PROVIDING AN INDICATION USING A MENISCUS MOBILIZER AND ELASTIC RESERVOIRS, AND METHODS, INDICATORS AND TIMEPIECES RELATED THERETO

(71) Applicant: Preciflex SA, Neuchâtel (CH)

(72) Inventor: Lucien VOUILLAMOZ, Feusisberg (CH)

(73) Assignee: Preciflex SA, Neuchâtel (CH)

(21) Appl. No.: 15/510,254

(22) PCT Filed: Sep. 11, 2015
(86) PCT No.: PCT/IB2015/001611

§ 371 Date: Mar. 10, 2017

Related U.S. Application Data
(60) Provisional application No. 62/048,869, filed on Sep. 11, 2014.

(51) Int. Cl. G04B 1/26; G04B 19/00

(52) U.S. Cl. CPC G04B 1/265; G04B 19/00; G04B 25/00

(57) ABSTRACT

The invention provides a system for providing an indication including a meniscus mobilizer, a meniscus mobilized by at least meniscus mobilizer, and at least one fluid forming the meniscus, such that mobilization of the meniscus by the meniscus mobilize is accomplished through the use of an electro-mechanical or mechanical sub-system. The system further includes a temperature control sub-system, whereby the temperature control sub-system securitizes and optimizes a meniscus displacement velocity of the meniscus. The system further includes an element of a vehicle, such as a windshield, indicators within the cockpit of the vehicle, ship, train, motorcycle or airplane. Optionally, the element comprises a transparent glass. The indication is an indication of time or other parameter such as speed, acceleration, etc. Indication is provided by means of a fluorescent active fluid that forms the meniscus. The invention includes an ultraviolet light generator. Optionally, the ultraviolet light generator is an LED, whereby the system is not lighted in an orthogonal direction and thereby invisible to a driver of a vehicle.

### COPYRIGHT & LEGAL NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. Further, no reference to third party patents or articles made herein is to be construed as an admission that the present invention is not entitled to antedate such material by virtue of prior invention.

### BACKGROUND OF THE INVENTION

This invention relates to indication, in particular systems which use a fluid medium to provide an indication, and methods, elements of vehicles, planes, trains, sportscars, ships, racing boats and timepieces related thereto.

### SUMMARY OF THE INVENTION

The invention provides a system for providing an indication including a meniscus mobilizer, a meniscus mobilized by the meniscus mobilizer, and at least one fluid forming the meniscus, such that mobilization of the meniscus by the meniscus mobilize is accomplished through the use of an electro-mechanical sub-system. The system further includes a temperature control sub-system, whereby the temperature control sub-system ensures and optimizes a meniscus displacement velocity of the meniscus. The system further optionally includes an element of a vehicle, such as a windshield, indicators within the cockpit of the vehicle, ship, train, motorcycle or airplane. Optionally, the element comprises a transparent glass. The indication is an indication of time or other parameter such as speed, acceleration, etc. Indication is provided by means of a fluorescent active fluid that forms the meniscus. The invention optionally includes an ultraviolet light generator. Optionally, the ultraviolet light generator is an LED, whereby the system is not lighted in an orthogonal direction to the driver and thereby, the light source is invisible to a driver of a vehicle.

In its most elementary form, the system includes a meniscus mobilizer which mobilizes a meniscus. At least one fluid forms the meniscus, such that mobilization of the meniscus is accomplished through the use of an at least mechanical sub-system, preferably an electro-mechanical subsystem.

In another level of complication, the system further includes a temperature control sub-system, whereby the temperature control sub-system securitizes and optimizes a meniscus displacement velocity of the meniscus.

In yet another variant, the system further includes an element of a vehicle, such as a windshield, indicators within the cockpit of the vehicle, ship or airplane. Optionally, the element comprises a transparent glass.

In yet a further aspect, the indication is an indication of parameter such as speed, acceleration, etc.

In yet another aspect of the invention, a fluorescent active fluid forms the meniscus.

In yet another embodiment, the invention includes an ultraviolet light generator. Optionally, the ultraviolet light generator is an LED, whereby the system is not lighted in an orthogonal direction and thereby invisible to a driver of a vehicle.

In another aspect, an indicator, energy storage and/or release system includes two elastic bellows in fluid communication with one another and filled with a fluid or fluids (whether liquids alone or in combination with a gas) thus allowing mechanical power transmission. The energy which loads the system comes from an external winding up of the system (which can be performed either manually or automatically). The winding or loading force is transmitted by a mechanism attached to at least one or the other fluid reservoirs. The mechanism is controlled by the controller and the fluid reservoirs are elastic. Consequently, once a first reservoir is expanded or contracted via the mechanism, then the second elastic reservoir will elastically seek to return to an equilibrium state. Of course, the control of the at least one or the other fluid reservoir is dynamic, when used as an indicator, particularly, when used as a tachometer and so, it is typically under constant control by the controller and returns to a “zero” state when deactivated. By using at least solely two immiscible fluids that are liquids, without gas, in the system, that energy storage effect can be used or not by the mobiliser, the mobilization of the meniscus may be achieved alternatively by pushing or pulling one or other of the flexible reservoirs in one direction or in the opposite direction.

The second bellows does not need to be a bellows per se, but could also be a flexible reservoir or balloon.

In yet another variant, the reservoirs are not the same size, and the device includes a channel, and in which a portion of the channel connecting the reservoirs is transparent and visible.

In yet a further embodiment, the indicator further includes at least two menisci, and wherein the at least two menisci are located between at least three different immiscible fluids.

In yet another variant, the indicator, at the point of the meniscus, includes a solid indicator and, optionally, the solid indicator is of a bright color to enhance visibility.

These and other objects of the invention are described in the drawings, detailed description of the invention, and claims related thereto.

In a preferred embodiment, the first reservoir is controlled in expansion and contraction via a shaft for piston that is attached to one of the reservoirs and is pushed and pulled under the control of controller, the second reservoir needs not to be controlled.

### BRIEF DESCRIPTION OF THE DRAWINGS

FIG. 1 is a schematic side view of an indicator system of the invention.

FIG. 2 is a schematic side view of a variant of the indicator system of FIG. 1 of the invention.

FIG. 3 is a schematic side view of an alternate embodiment in which at least four fluids indicating two or more menisci are used.

FIG. 4 is a partial schematic side view of a UV generator used in combination with the system on a windshield of a movable vehicle.

FIG. 5 is an interior view of a sports car where the various systems and sub-systems of the invention are used.

FIG. 6 is a schematic view of an alternate embodiment of the invention.

FIG. 7 is a table showing four further alternate arrangements of the fluids in the tube or canal.

Those skilled in the art will appreciate that elements in the figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, ‘back’. ‘top’ and ‘bottom’, and the like in the description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENT

The following description is not intended to limit the scope of the invention in any way as they are exemplary in nature and serve to describe the best mode of the invention known to the inventor(s) as of the filing date hereof. Consequently, changes may be made in the arrangement and/or function of any of the elements described in the disclosed exemplary embodiments without departing from the spirit and scope of the invention.

Referring now to FIG. 1, a system 100 is provided to provide an indication as to speed, time, and pressure, within an indicator display in a cockpit of a propelled vehicle, ship, race car, automobile, train, motorcycle, airplane, and the like. The system 100 includes visible (to the user in one variant, and in another variant, invisible to the user) pistons 102, 104, 106, 108. Pistons 102 and 104 are connected by tube 110. Pistons 106 and 108 are connected by tube 112. Tubes 110 and 112, respectively, comprise a colored liquid 114, 116 in one variant of the invention. The system 100 is placed within housing 118. Indications provided by the systems described herein are various, and include measurements of parameters related to engine function, exterior environmental parameters, interior environmental parameters, acceleration, deceleration, brake function, power train function, fuel gauges, pressure gauges, temperature gauges, time, and the like.

Now referring to FIG. 2, a variant of system 100 of FIG. 1 is system 200. System 200 includes two or more substantially circular tubes 202, 204. Tubes 202, 204 (and/or the fluids and menisci therein) are visible to a driver, or partially visible to a driver. Each of the respective tubes 202, 204 is in fluid connection with and has a fluid therein driven by bellows 206, 208, 210, 212. Bellows set 204, 206 and 210, 212 are also optionally visible to a driver in one variant of the invention and are set at an angle to one another, e.g. in the range of 0-180 degrees. This variant is useful for speed indication within a cockpit, e.g. a sports car or other vehicle cockpit. The systems of indicators described herein can be used alone or in combination with other standard speed, temperature, etc. indicator systems commonly found in cockpits.

Now referring to FIG. 3, an alternate embodiment of system 300 includes at least to four fluids 302, 304, 306, 308 indicating via two menisci 310 and 312 in tubes 322, 324 which are in fluid connection with their respective bellows, electro/mechanical/fluidic sub-systems. In this variant, bellows 314, 316, 318, 320 are parallel one to another and in combination with electrical and mechanical sub-systems form a meniscus mobilizer.

The systems 100, 200, 300 for providing an indication include one or more meniscus mobilizer sub-systems, one or more menisci 310, 312 mobilized by the meniscus mobilizer, and at least one or more fluids 302, 304, 306, 308 forming the meniscus, such that mobilization of menisci by the meniscus mobilizer is accomplished through the use of one or more electro-mechanical-fluidic sub-systems such as those described herein.

The systems 100, 200, 300 further include a temperature control sub-system in the housing or around one or more components of systems 100, 200, 300, whereby the temperature control sub-system securitizes and optimizes a meniscus displacement velocity of one or more of the menisci.

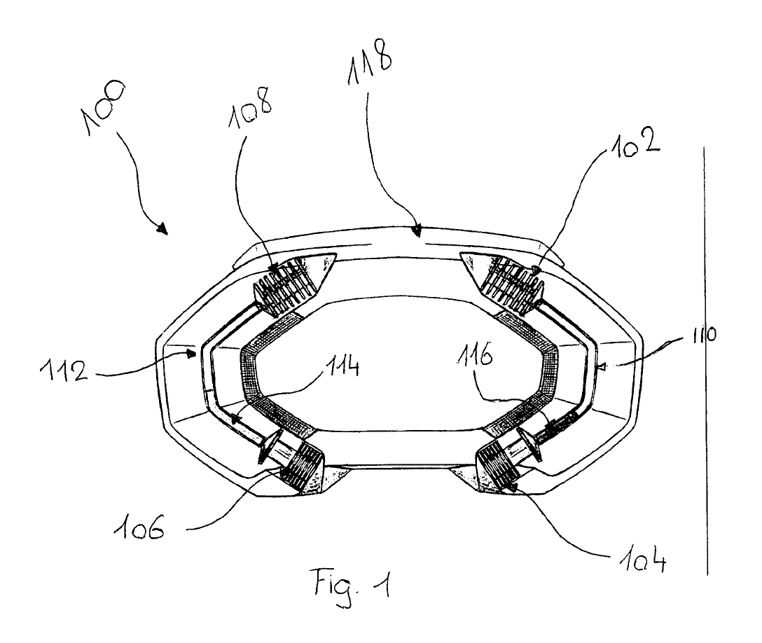

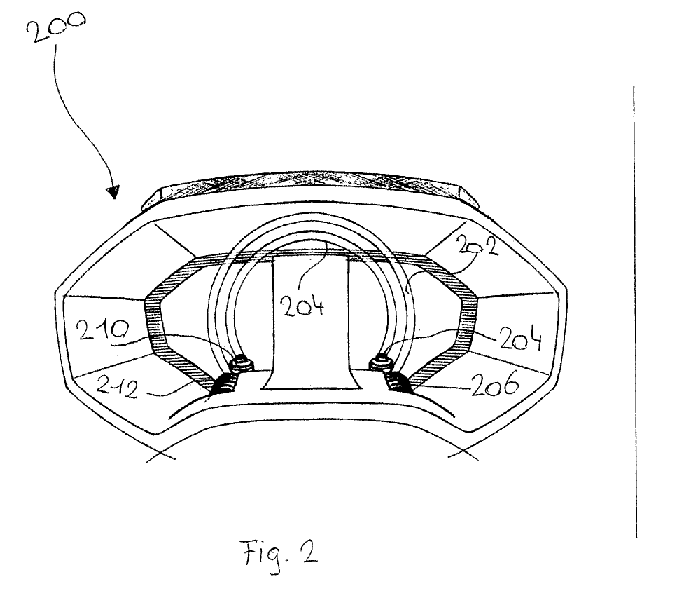

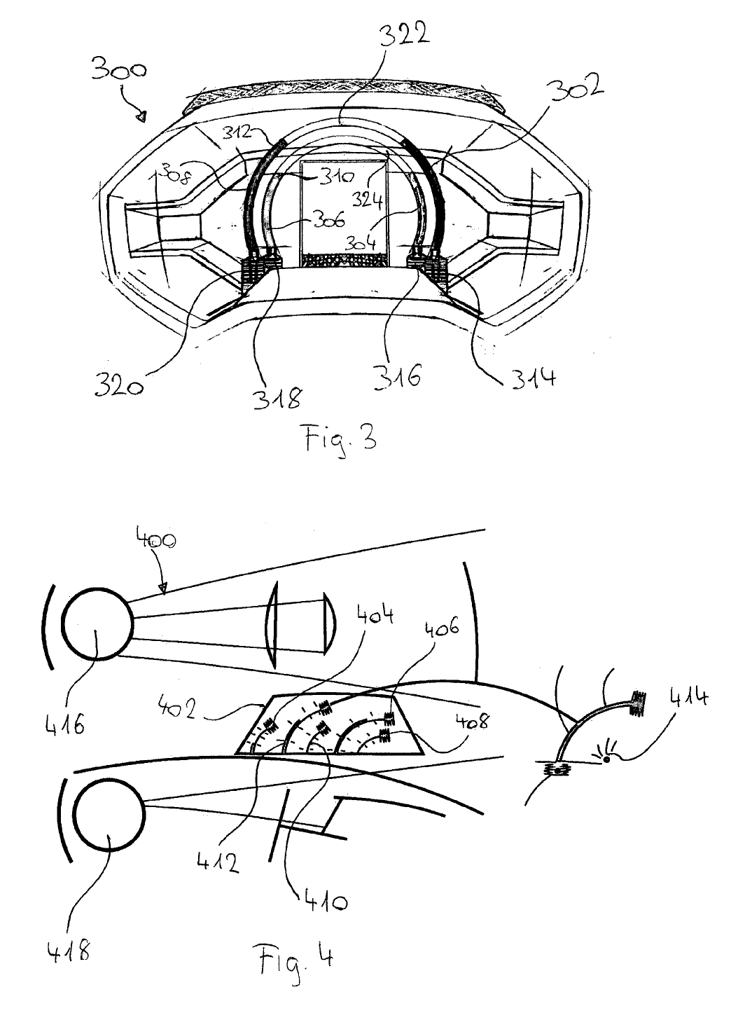

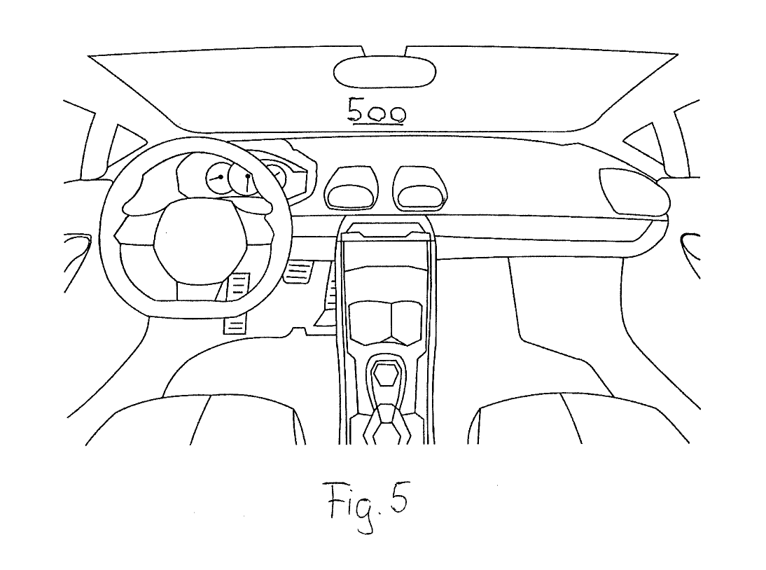

Now referring to FIG. 4, one or more of the systems 100, 200, 300 are incorporated into a moving object, e.g. a vehicle, boat, motorcycle, or component thereof. As shown by system 400, one or more sub-systems 404, 406, 408, 410, 412 (similar to or analogous to systems 100, 200, 300) can be disposed in parallel on or in a windshield 402 (of course other geometric configurations are also used herein) of a car. Or course, one or more systems may be utilized on the side windows, and or rear window of the moving/self-propelled or wind propelled object also, or on any interior or exterior component thereof, e.g. brake lamps, turning signals, etc. In yet another embodiment, the invention includes an ultraviolet light generator 414 positioned to provide activation or visible color to the fluids 310, 312 in one variant of the invention. The generator 414 is an LED in one variant. The positions of the one or more UV generator(s) 414, 416, 418 can be on various places on the vehicle as shown in FIG. 4, and can optionally include lensing or diffusion systems. Optionally, the ultraviolet light generator is an LED, whereby the system is not lighted in an orthogonal direction to the driver or viewer, thereby permitting the LED source to be invisible to a driver of a vehicle.

The systems 100, 200, 300, 400 further include, in combination, any element of a vehicle or movable or stationary object, such as a windshield, indicators within the cockpit of the vehicle, ship or airplane. Optionally, the element comprises a transparent glass. The indication is an indication of time or other parameter such as speed, acceleration, etc. Any type of variable indication is provided using the systems and sub-systems of the invention. A fluorescent active fluid forms the menisci 310, 312 in one variant of the invention.

Now referring to FIG. 5, the interior of sports car 500, e.g. a Lamborghini is shown. The systems 100, 200, 300, 400 are used in any location for indication of variables within the cockpit of the car 500 or in the other interior or exterior of the vehicle.

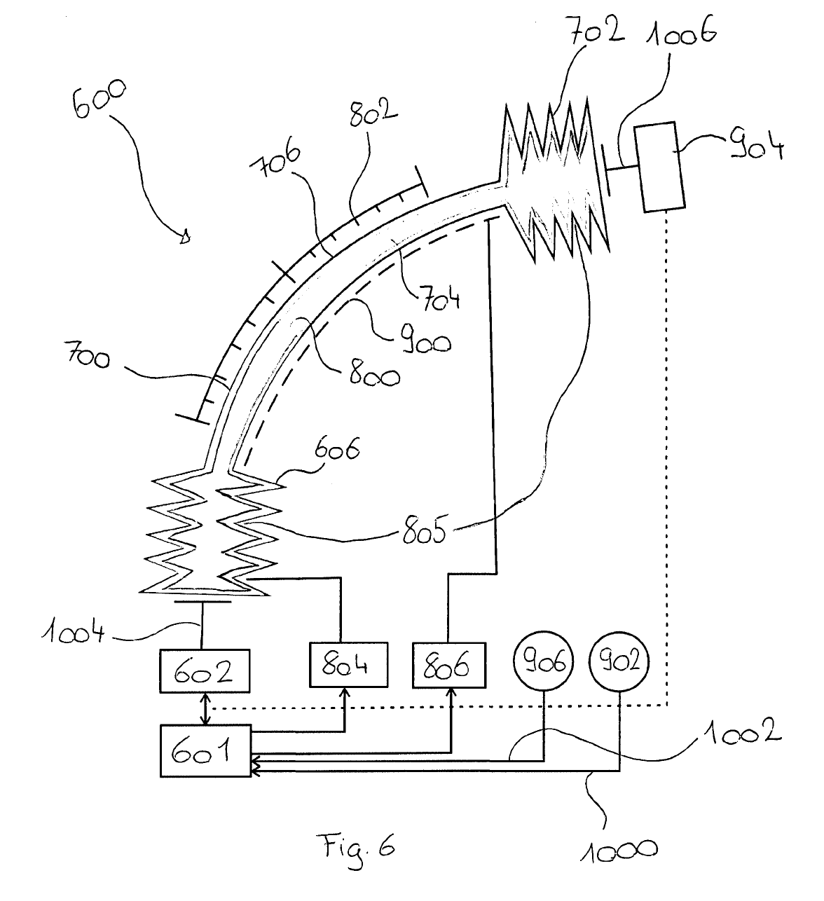

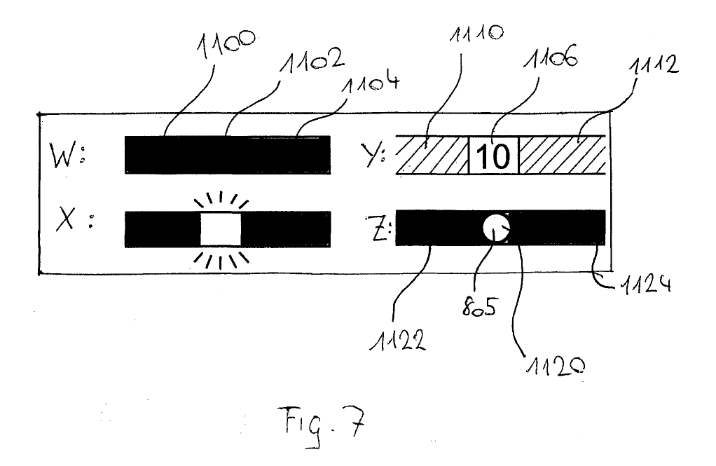

Referring now to FIG. 6, an alternate embodiment 600 of the invention includes a control system 601, a first bellows actuation system 602, a data input 604, a first bellows 606 containing a first fluid 700, a second bellows 702 containing a second fluid 704, a canal or tube 706 connecting the first and second bellows allowing the first and second fluid to communicate through the canal or tube and to form an interface 800 such as a menisus 801 therebetween, an index 802 juxtaposed to the canal or tube, a heating system 804, a general illumination system 806, a liquid illumination system 900, an on/off device 902 and, optionally, a second bellows actuation system.

The first fluid 700 is an active, typically colored fluid which indicates the value 906 to be indicated.

The tube or canal 706 containing the nonmiscible fluids 700 and 704 has any cross section, such as a circular, oval, square or polygonal, dimensioned in such a way that a stable meniscus 800 may be maintained at maximum displacment conditions desired at the operating temperatures maintained by the heating system 804.

The system 600 is under the control of a control system 601, which receives an to activation signal 1000 from the on/off device 902, as well as a data input signal 906 from the value input 1002. The control system 601 sends this information to the first and, optionally, the second bellows actuation system 602, 904, respectively, in order to control the same to position piston 1004, and, optionally piston 1006, respectively, in order to control the position of the interface 800 or meniscus 801. In order to attain an advance or return of the interface, controlled activation is necessary, which may be of only one of the first or second bellows activation systems 602 and 904 in a preferred embodiment. It should be emphasized that where the single bellows activation system 602 or 904 is connected via a shaft or piston 1004 or 1006 to one bellows, the piston is connected so as to be able to push and pull, as necessary, one end of one bellows (via a mechanical connection or fixation thereto), thereby allowing the second bellows to be passive, in that it mechanically adapts to the inputs and so allows the controller to place the meniscus at a desired location along the indication.

Concerning the design of the bellows 606 and 702, the bellows can be of the type that consists of flexible membranes. However, the device appears to function best when we avoid the use of a plunger with a piston moving into a cylinder, because of the tightness is an issue. A suitable bellows is made of metal and has an accordion form. Such a bellows is described in detail in the documents incorporated by reference herein.

The heating system includes a temperature controller 804 and at least one heating coil 805. The heating system 804, 805 controls the temperature of the device 600 to insure that the fluids that are liquids are maintained at a specific temperature at which the fluids have no risk of emulsion due to variations in the viscocity at the maximum displacement speed expected for the menicus.

Control of the viscosity of both fluids 700 and 704 is important for accurate indication and in order to have an absolutely stable behavior of the meniscus 801. It has been learned through experience through testing that if temperature is too low, the mensicus 801 may only be moved at a limited speed without risking breaking up. Further, when the invention is used in a car, a very wide temperature range is possible. Consequently, controlling temperature to yield predictable and reliable results is very important. By removing temperature as a variable we avoid the need for thermal compensation and thus simply the device 600.

The general illumination system 806 (for example, UV) is provided for optimizing reading in the dark. The liquid illumination system 900 illuminates the fluids 700, 704. The second fluid 704 is a passive fluid, in that it contains a typically clear fluid. The passive fluid 704 is typically driven by the active fluid 700, in a variant with only one bellows having a bellows activation system 602.

In another embodiment, instead of maintaining a constant temperature environment, displacement invoked by the system is corrected to account for thermal expansion of the fluids used therein, such as with the thermally compensated bellows (compensated capillary indicator) in the patent references herein incorporated by reference or by otherwise appropriately adjusting the volume of one or both bellows 606, 702. However, this has the disadvantage the the fluids are not heated above ambient, below the optimal operational temperature.

The use of two reservoirs as described herein allows the sizing of each reservoir to enable an adaption of the displacement in the first reservoir so as to result in a desired rate of displacement of the second reservoir, which may be used to select a more conventional gearing system, or to produce another desired effect. The use of two bellows allows the placement of the indicator channel therebetween to indicate the energy state of the system.

Other embodiments are shown and described in appendices attached to the priority filings, which is incorporated herein in this written description. Variants A-H are also used, in combination, with the invention described herein. In the instant invention, the piston is driven by, for example, a rack and pinion gear system preferably driven by a known electrical or mechanical watch movement in the variant in which the indication system is used to indicate time. Of course, in place of the rack and pinion system, a screw or other suitable drive may be used.

### Example of Variant A

In Variant A, a visual indicator display device is used in combination with the invention and includes a bracelet, a transparent capillary chamber, and a displacement member. The transparent capillary chamber is matched to an indicia and has a primary length and a width less than the primary length. The displacement member is functionally disposed at one end of the capillary chamber and is responsive to a measureable input for moving a fluid contained therein a defined amount. In another embodiment, the visual indicator display device includes a transparent capillary chamber, an associated indicia and a displacement member. The capillary chamber has a first end for containing a first fluid and a second end for containing a second fluid immiscible with the first fluid so as to form a meniscus between the fluids which is visible through the capillary chamber. A suitable fluid may be an oil, a lotion, or a liquid such as a drug or other medication. The displacement member is attached to one end of the capillary chamber which is responsive to a measureable input for moving the fluids to displace the meniscus allowing the user to read a measurement from the indicia.

An analog., indicator of the invention indicates time. The indicator includes a reservoir, a pump, a measuring device, a feedback circuit in a controller and a power supply. The reservoir has a longitudinal axis along which a indicia or a scale device is disposed and is adapted for containing a fluid bounded by at least an indicator surface, generally the meniscus of the fluid (such may also be a surface of a plunger, floating piston, float member or barrier which separates the fluids of like color). In a preferred embodiment, the pump is made up of a plunger mounted on a screw driven by a micro motor. The plunger generally uses an O-ring seal disposed about its circumference, to seal against the fluid passing between the top and bottom surface and, respectively, of the plunger. The pump pumps the fluid into and out of the reservoir, by varying the volume of a lower reservoir. In a preferred embodiment, the measuring device is an electronic clock which measures time and communicates a measured value of time to the feedback circuit. The feedback circuit, powered by the power supply, receives a measured time input from the measuring device corresponding to a position on the scale device and, in response thereto, activates the pump to pump or move the fluid from the lower reservoir into the reservoir, until the surface of the fluid reaches a desired position in relation to the corresponding position on the indicia. The power supply powers the pump and feedback circuit. As shown, the reservoir communicates the first fluid, or a second fluid, to an opposite side of the plunger, to act on the bottom surface thereof. In this manner, pressure is equalized on each side and of the plunger, and a pressure relief reservoir is not required (a closed loop).

Further, optionally, an optical fiber and an LED light source illuminate the fluid in the reservoir in a known manner (such as lighting via an LED into the fluid).

A potentiometer regulates the voltage setting to a displacement control system (using a hall effect sensor). The displacement control system includes an incremental position sensor, for example, the tracker NSE-5 located adjacent the plunger. This control system includes encoding for direct digital output, in which a hall element array on the chip is used to derive the incremental position of an external magnetic strip placed adjacent the chip at a distance of approximately 0.3 mm (typically), the magnetic strip being attached to the plunger in order to translate therewith. This sensor array detects the ends of the magnetic strip to provide a zero reference point.

To return the fluid to an initial position, such as 6:00 AM, for example, the plunger may be returned by a return spring or a magnetic device (not shown). Other options are conceivable, of course, which include the return line, which allows simple reversing of the motor 43 to reset the indicator.

A suitable motor is referred to by its trademark SQUIGGLET™, available from New Scale Technologies, Inc. of New York, USA.

The reservoir may be made of a transparent or translucent material, or a mixture of transparent and translucent material, formed in any desired shape. It may be made of plastic, rubber, silicon or any suitable material.

The said fluid passes via two channels into the circumferential channel. The two fluid reservoirs are thereby in fluid communication via two passages and two channels.

The cam is formed resembling a nautilus spiral so as to progressively move the piston shaft and therefore the piston head to displace a determined amount of fluid into the capillary channel, at a rate which will indicate the time accurately. Of course, a similar determined amount of drug or perfume may be administered to living organism in this manner as well.

For priming, a septum or access port (not shown) or pair thereof, made of an elastic material, may also be used to allow removal and injection of air and fluid and into and out of capillary channel and/or reservoirs.

### Example of Variant C

The pump is preferably a gear pump equipped with two wheels with external teeth, or internal gear pump which requires less space. The gear pump is driven by the watch movement which also determines its rotation speed. The housing of the pump is preferably transparent, and can be made of synthetic material or glass, to show the rotation of the drive to gear and the fluid. In one embodiment, the housing is made from several sheets of glass or transparent material superposed one another. The plates are preferably welded to each other and to the channels by high temperature melting. The gears are held in the housing by pins through the housing and/or maintained in pivots or blind holes. An axis may be directly driven by a gear wheel or a conventional watch movement.

Other types of pumps, such as centrifugal pumps, peristaltic or membrane can also be used according to the time information to display, the fluid used and the fluid path. However, a gear pump can be operated gears that are common components in watchmaking, and easier to visually integrate into a movement and manufacture industrially.

The pump and the distributor may be visible from the top or bottom of the watch, or sides, allowing you to view the operation and the path of fluid flow in the watch. In a preferred embodiment, the pump, the tank and the entire hydraulic circuit are mounted in an auxiliary module to be superimposed or juxtaposed to a conventional watch movement base, which drives and controls and is thus possible to add a hydraulic or pneumatic display according to a conventional watch movement, overlapping the new hydraulic display module to the basic movement. For example, The pump is constituted by a transparent glass module superimposed over existing watch movement, and meshed with one of the axes of the movement, for example through the axis of the seconds wheel leading directly or via a return of the two gears of the pump. The pump is then located between the movement and the crystal, and is driven from below by a pin, and connected on the top to the channels to carry one or more drops of fluid in the channels.

The watch movement comprises a power source, for example a cylinder or a stack, a regulating member, for example a rocker assembly/spiral or a crystal oscillator, as well as transmission elements, including for example a train of gears and pinions. Other elements, including complications etc. can be provided. The power source can also activate to the pump.

The pump causes the fluid from the tank in channels through the crystal or transparent face shows to display temporal information or other information directly into the glass. The channels typically have portions parallel to the display surface of the glass, as well as holes perpendicular to this surface and to connect the pump to the dispenser and in motion.

The geometry and dimensions of the channels in the crystal or transparent face and in the rest of the watch are chosen so as to allow filling without bubbles when the bubbles are undesirable. For this purpose, the lowest sections of the channels are of one square millimeter, for example between 0.1 and 10 square millimeters, which allows to discharge the bubble with acceptable overpressure in the system, for example a few millibars overpressures only. It also avoids preferably too abrupt changes in direction, such as angles, and complex or too thin geometries which can cause obstructions bubbles in narrow passages and block the flow of fluid.

As mentioned, it is also possible to make channels that are embedded or formed in the crystal or transparent face and are filled with two immiscible fluids, one of which indicates its position temporal information.

The liquid (or other fluid) is preferably colored to better see the channels, clear fluids may also be used, however, if they change the refraction on the inner surface of the channels in order to make them visible when full. Fluid flow through these channels and to modify the opacity and/or color of the glass in areas where the channels pass, depending on the position of the fluid in the channels. Phosphorescent liquid visible at night, for example, liquids with phosphorescent or luminescent particles may also be used.

The path of the channels in the crystal or transparent face may have bifurcations to selectively fill various channels or cavities in the glass. The information displayed then depend channels/cavities are filled every moment. The circuit includes a single channel in a closed loop, wherein one or more flow fluid bubbles or drops whose position provides a time indication. In a preferred embodiment, the position of the drop corresponds to a second slider and is incremented every seconds, and the displacement of the drop can be consistently and continuously or in spurts all seconds.

It is also possible to use multiple segments of colored liquid, whose position in the channel displays an indication. Both solutions can also be combined to display information through drops, bubbles or segments of colored liquid that selectively way along several possible paths. It is also possible to display information using gas bubbles or light fluid rising through another liquid, the dividing line between the gas and the liquid for displaying an indication.

If the channel in the crystal or transparent face or in the movement has bifurcations, the device such as a watch may include microvalves to control the path chosen at each instant by the liquid. These microvalves can be mounted in the glass. However, they are difficult to conceal, and also have the disadvantage of being easily blocked, e.g., due to bubbles or impurities.

Alternatively, or in addition, it is also possible to use multiple pumps controlled independently from each other to selectively send a fluid in a channel or another. For example, one channel can carry a first drop of liquid to display the current second, while a second channel can carry another drop indication showing another example of the second chronograph. Each channel or fluid circuit may have its own pump, as indicated, a single pump can also cause drops in several circuits.

The passive microvalves, that is to say, without moving parts, and/or microdiodes, can also be used, for example microdiodes Tesla-type, convergent-divergent or Vortex, which allow regulating and controlling the flow of fluid in a reliable and repeatable manner over time.

The path followed by the fluid depends on the viscosity of the fluid of the inner to walls of the canal and the pressure applied by the pump. It is thus possible to control the path traveled by and/or the flow velocity of a bubble or a drop in the working channel on the choice of surface tensions of the liquids and the wettability properties and characteristics hydrophilic or hydrophobic surfaces of the channels, and on the shape and surface condition. Preferably, no active microvalve is used in the fluid circuit.

A drop of a second fluid flows through an annular path to the periphery of the crystal, so as to simulate the movement of a pointer second via colored liquid in the glass. The liquid droplet preferably has a high viscosity so as not to be split even when the watch is swung and is pushed into the annular channel by a first differently colored fluid, e.g. a gas or a second transparent fluid immiscible with the liquid of the drop, and put into displacement by the micropump. The viscosity and/or color of the two fluids are different, and they are not miscible. Cavities may be provided in the annular path, e.g. successive cavities mutually spaced 6° apart, drop pass from one cavity to the other every second, driven pump that can be operated in a pulsed manner. The diameter and shape of the cavity may be of different diameter and/or shape of the channel between the cavities, so as to cause the droplet to stop in the cavities respectively. It is also possible to apply to the inner cavity surface microstructuring or other treatment differing from that applied to the channel area, in order to assist the drop in discretely move and indexed from one cavity to another. As noted above, this view of a second drop, as described in this section can also be used with a channel that does not pass through the glass.

The representation of the passage of time may also be realized by a swirling motion of the fluid in the watch glass, or a laminar motion in a path whose shape evokes a vortex or other figurative or abstract decorative form. Cavities of different shapes and volumes then followed to return the fluid to the distributor. It is also possible to employ a circular channel which is wound upon itself with a flow velocity which is accelerated towards the center of the performance until a discharge duct close to the center of the glass. The acceleration and deceleration of the fluid can be made visible by bubbles, drops or to inhomogeneous fluid mixtures.

The choice of an appropriate texture on the inner surface of the channels to change the contact area of a droplet with the surface. For example, applying the points—for example carbon nanotubes, glass or on the inner faces of the channels, one can significantly reduce the wetting and obtain a channel extremely hydrophobic. Sometimes the “fakir” effect speaks, the drops cannot slip between the peaks of the roughness tend to perch on the tips rather than wet surface portions between these points. The fluid surface-channel contact is considerably reduced, which facilitates the flow, reduce friction and reduce the energy required to move the fluid. Appropriate choice of structures in different parts of the fluid path can also control the flow and course of different fluids or speed. It is also possible to exploit these microstructures to create cavities large area in which the fluid is moving very quickly and with reduced friction, which can be filled and empty them almost instantly.

Other variations, including s simulated needle rotating inside the glass, may be used. For example it is also possible to move drops continuously and progressively, or to advance several drops simultaneously or at different speeds in different channels. Moreover, it is possible to use channel in diameter and variable section along the channel to change the flow rate and/or the surface of the visible drop by the user. For example, it is possible to transform a highly concentrated spreading it over a large area, then make him take a more compact form to create amazing animations in the crystal or transparent face drop. In another embodiment, it is possible to combine several drops, for example by making every second or at regular intervals a drop in the tank with the fill indicates the number of seconds of the current minute, and then separating the fluid. This reservoir drops to the end of the minute or during the next minute. Other flow frequencies can be used. A microdispenser can be used to separate a volume of fluid in smaller amounts.

The glass with an outer crystal or transparent face of a hard material, and internal crystal or transparent face easier to machine or burn material is also used in the invention.

A channel or cavity is etched in the lower layer, and selectively filled with colored fluid by the pumping action of the pump. The different parts or layers of the crystal or transparent face may be hermetically sealed together, for example by thermal or chemical bonding. Micro-holes in the bottom allows the passage of fluid for supplying the channel.

The dispenser ensures the connection between the channels in the glass, and other Is elements in the movement where the fluid flows. The distributor may also be made of several elements tightly assembled and include channels and holes for dispensing the fluid. Flexible or rigid micro pipe can also be used. The micro-machining of tough and transparent materials can be achieved by methods:

Mechanical: diamond tool, sandblasting, water jet with abrasive ultrasound with or without abrasive

Chemical: photogravure, wet etching, dry etching

Electroheat: laser

Electrochemical: SACE etching [0064] The method used for the machining of hard, brittle and transparent parts is selected to ensure a good surface, that is to say, with a low roughness to preserve the transparency of the materials after machining. The use of several technologies combination for a hole and/or a room provides the feasibility and qualities to achieve the required micro-machining. For micro-channels and micro-cavities, chemical machining is advantageously chosen while for micro-holes are to be oriented such that the electrochemistry provides a depth/diameter ratio greater than 10, and thus obtain better quality in shape and repetitive micro-holes. Where the transparency of materials is not a necessary condition, as the distributor or other hidden items, we can use the laser processing and post-processing such as “grandissage” or “polishing”.

As indicated, canals, cavities and grooves can also benefit from a surface treatment (microstructure) or a surface coating to reduce glare particular, to control their wettability to with the fluid, reduce friction of the fluid on the walls and/or guarantee non-turbulent flow. The housing of the pump is advantageously produced by chemical or electrochemical machining. The shaft sealing drive can be provided by a seal, not shown. The fluid reservoir (optional) can be integrated to the distributor and/or be mounted in the crown, in the bezel, or in the case of the watch.

The connections between the different channels and supply holes are preferably made without connections to facilitate installation and avoid sealing problems. For example, the connection between the channels and the glass tubes or channels of the movement can be performed carefully aligning the box with crystal or transparent face—preferably by means of a mechanical stop, a pin (for example) so as to precisely match the open ends of the channels in the crystal or transparent face and in the box or moving. The seal is then obtained by bonding, for example UV bonding, or by thermal fusion (“fusion bonding”) of the two juxtaposed channels.

In the watch glass or in the movement, it is filled or emptied of fluid in a pulsed manner, so as to beat the second. This cavity can be covered with a membrane, the pulsation of the fluid in the channel behind the diaphragm vibrates or draws a form in a particularly visible and interesting fashion. The membrane can be colored and/or be provided with a form and a decorative pattern, such as a heart. Several vibrating membranes, synchronized or out of phase in the same watch, can be used.

The liquid can also be used for other purposes, for example, causing the appearance in the crystal or transparent face interesting complications showing seconds, jumping seconds, chronograph seconds etc. The second display is advantageous because the problem of setting the time and placement of the drop of colored liquid in the right place along its route arises less. It is however also possible to use this hydraulic solution to display additional information corresponding to longer periods, such as minutes, hours, date calendars etc. Means of setting the time manually moving the drop by a manual pump can then be advantageously implemented, these means of manual pumping can simply use the setting circuit for a conventional hour, which activates the pump to move the drop.

The use of fluid also lends itself advantageously to display indications in a countdown format, for example countdown regatta, or to display ties etc., as done via the countdown indicator used during traditional Times Square New Year's celebrations.

In a preferred embodiment, the watch will display a timed duration, e.g. a second chronograph, using a liquid drop. It is also possible to provide a chronograph ink wherein an elapsed time is displayed by depositing a drop of liquid at the beginning of the period, and a second drop at the end of the timed interval. It is also possible to have multiple overlaps or intersections at different levels in the crystal or transparent face to display complex information or change the color in areas of overlapping channels.

It is also possible to use a crystal or transparent face or layers in the glass, some or all polarized, and the fluid flows can change the polarization direction in the channel in order to achieve color changes or significant opacity. The present invention also relates to additional modules to be stacked or combined over a conventional watch movement and to work with such a watch movement conventional to display a time indication by means of a fluid moving in a channel through the crystal or transparent face and/or by means of a drop of a second fluid moving in a fluid filled in a first channel to display an indication temporal.

### Example of Variant E

This invention relates to hydraulic fluid systems, and in particular, hydraulic systems used in consumer products in which at least two fluids occupy a single container, and the level of the interface between the fluids is to be adjusted. What is needed is a means of limiting fluid flow or restricting it to a controlled flow so that the fluids do not mix when a meniscus between the fluids is moved.

In another variant, a capillary system is provided for a fluid indicator. The system to includes at least one fluid restrictor, and a capillary channel or tube. The fluid restrictor has a small aperture formed therethrough. The capillary tube is adapted to receive at least two immiscible fluids. The fluid restrictor is sealingly affixed into at least one end of the capillary tube so that the small aperture communicates between the inside of the capillary tube and the outside of the capillary tube. The capillary tube is optionally treated so that an inner surface is oilophobic and hydrophobic. A fluid is pumped through the fluid restrictor into the capillary tube to move the meniscus formed between the fluids contained therein. An object of the invention is better control of the interface or meniscus between the at least two fluids contained in the capillary tube, preventing mixing.

The fluid restrictors, combined with coating of the capillary tube provide significant advantages when used in a watch, for example. The restrictors prevent excessively rapid movement of the meniscus between the two fluids within the tube, especially when setting the time, or during the return cycle at 6 am in the morning or evening (i.e., a retrograde system). Indeed, without them, one of the two fluids can disrupt the other, depending on the temperature, by creating a channel in the other. Note that in some embodiments, the capillary tube is a capillary channel (rectangular, triangular or irregular in cross section), formed in a plate, against which the dial is sealingly affixed. Consequently, the term “tube” and “channel” are intended to be interchangeable herein and to include channels or tubes of all crosssections including oval, square, rectangualar, polygonal, etc. The capillary tube and the fluid restrictor need not have circular inner apertures. In fact, such may be square, triangular, or irregular apertures. These may also be adapted to such a non-circular channel formed in the plate. The coating improves the behavior of the meniscus against the walls of the capillary and together with an appropriate ratio of the apertures 26 and 34, helps prevent the disruption of the meniscus.

The fluid restrictor, a flow impediment placed in the fluid path that helps prevent too rapid movement of the meniscus in order to avoid its breaking up, is preferrably a to ceramic or stone but may also be a metal. The fluid restrictor is formed as a cap-shaped element having a flange thereon which prevents the fluid restrictor from entering the capillary tube more than a prescribed amount. A tiny hole (a few microns in diameter) in the fluid restrictor, glued on at least one end of the capillary tube, is preferably located along the axis of the fluid restrictor. The function of the fluid restrictor is the stability of s the meniscus, and the protection of the system.

The hole or aperture in the fluid restrictor has a width of between 0.03 and 0.1 mm in diameter. The aperture of the capillary tube has a width of between 0.6 and 1 mm, preferably 1 mm in diameter. Preferably, the ratio between the widths of the hole of the fluid restrictor and that of the capillary tube is 1:5 to 1:15, for fluids having viscosities between 0.3 et 80 cP at room temperature, sea level, and preferably 0.3 a 5 cP.

The hole or aperture of the fluid restrictor is formed such that the exit port of the aperture which exits into the capillary tube enters the capillary tube at an angle to the central axis of the fluid restrictor. This reduces the chances that the incoming stream of fluid will disrupt the meniscus, particularly when the meniscus is near the fluid restrictor, by diverting the flow away from the center of the meniscus to the sides. Still further, several such holes connecting to a single central hole of the fluid restrictor may further help diver the incoming fluid flow away from a center of the meniscus.

Fluid restrictors of the invention, are shown installed in the ends of a single capillary tube (the tube is curved back on itself). Ends of the fluid restrictors and capillary tube are shown in cross section, for clarity. A fluid restrictor is installed half way into an end of a capillary tube, ready to receive a dose of a suitable epoxy.

Any number of glues may be used to affix the fluid restrictor to the capillary tube. Two have proven to be particularly effective. “VITRALIT”® 1605 from Panacol AG of Steinbach, Germany, diluted with a thinner, is one and has the following characteristics: “VITRALIT”® is thermally cured (30 min @105° C.) and/or UV cured (s @UV-A 60 mW/cm2, thickness step: 0.5 mm). Further, it is a one component epoxy and has a to viscosity in the range of − cPs (@25° C.). As for “EPO-TEK”® 301, available from Epoxy Technology, Inc of Billerica, Mass. is thermally cured (1 hr @65° C.), is two component (20:5), and has a viscosity in the range of 100-200 cPs (@23° C.), which is significantly lower than “VITRALIT”®.

The gluing procedure involves the following steps: In a first step, plasma cleaning Is of both capillary and fluid restrictor is performed. In a second step, the fluid restrictor is placed half-way into the capillary tube. In a third step, a drop of glue is placed on the end of the capillary tube with a standard disposable needle In a fourth step, observing to ensure that the epoxy is properly distributed around fluid restrictor. In a fifth step, the epoxy is allowed to penetrate around the fluid restrictor and into the capillary via capillary action. In a fifth step, the epoxy is allowed to dry or set.

Note that it has been found that “VITRALIT”® 1605 alone is too viscous to promote capillary action between capillary tube and the fluid restrictor. To be suitable, it should be thinned with an appropriate thinner, whereas “EPO-TEK”® is suitable without thinning.

It has been observed that when the glue does not completely surround the fluid restrictor, unacceptable leakage may result. Again, Vitralit® 1605 is too viscous for capillary action between the capillary tube and the fluid restrictor 10. “EPO-TEK”® is suitable as is. Deposition is critical. If the glue does not surround the fluid restrictor, it is not possible to add glue later, or to add glue via the capillary tube. Note that these tests were performed with capillary tube having an OD of 02 mm and an ID of 01 mm. As for alternative gluing procedures, inserting a small O-ring around the fluid restrictor helps ensure that the aperture in the fluid restrictor is not blocked by the glue. The modified procedure for gluing using the O-Ring includes the following steps. In a first step, both capillary and fluid restrictor and the O-ring are plasma cleaned. In a second step, the O-ring is placed over an end of the fluid restrictor. In a third step, the fluid restrictor is placed halfway into the capillary tube until the O-ring is in contact with the end rim of the capillary to tube. In a fourth step, a drop of glue is placed on the exposed circumference of the fluid restrictor with a standard disposable needle or an oil dispenser. In a fifth step, the glue is observed to ensure that it penetrates sufficiently. In a sixth step, the fluid restrictor is fully inserted into the capillary tube and the O-ring is removed. In a seventh step, the epoxy is allowed to dry or cure. O-ring prevents the hole of the fluid restrictor from being clogged is by the glue. Note as well, that in addition to the fluid restrictor, a coating of the inside surface of the capillary tube is important to reliable and repeatable control of the meniscus between the fluids in the capillary tube. The fluid restrictors prevent a too rapid movement of the meniscus, especially, when the system is used in a watch such as that described in the above identified PCT application, in setting the time, or return at 6 am in the morning or evening (retrograde system). Indeed, without these features, the risk is that one of the fluids can create, depending on the temperature, a channel in the other. The coating allows it to improve the behavior of the meniscus against the walls of the capillary tube.

### Example of Variant F

In another variant, of the invention, in combination with the features described herein, a bellows is provided for fluid storage and displacement used in precise fluid indication in a capillary tube. The bellows defines a housing made of flexible, watertight material. The housing is made up of an upper portion, a lower portion, and an outer accordion formed portion. The accordion formed portion has a length/and is sealingly connected along a periphery between the upper and lower portions. At least one entry/exit port is formed on at least one of the portions thereof. At least one of the upper and lower portions extends from a periphery of the accordion formed portion substantially within the housing so as to reduce the storage volume within the bellows. A large interface to an actuation device while containing and precisely controlling a small volume of fluid in order to minimize the impact of thermal expansion or contraction of the fluid is provided. Another object of the invention is to control a small volume of fluid which enters a preferably transparent capillary tube.

In the combined invention, a bellows is provided for fluid storage and displacement used in precise fluid indication in a capillary tube. The bellows delimits a housing made of flexible, watertight material. The housing is made up of an upper portion, a lower portion, and an outer accordion formed portion. Each portion may be of a differing material or be coated or partially coated via a masking so that at least a portion of which has a certain coating and the remaining portion another coating or none at all, assuming that the process for assembly of the portions, and (laser, ultrasonic or friction welding, epoxy or adhesive, brazing or soldering, for example) is compatible therewith. The accordion formed portion has a length/and is sealingly connected along a periphery between the upper and lower portions. The sealing may be accomplished via an adhesive or epoxy bond, or a brazing or other welding or soldering process, known in the art. Laser or ultrasonic welding may also be used. At least one entry/exit port is formed on at least one of the portions thereof. At least one of the upper and lower portions, extends from a periphery of the accordion formed portion substantially within the housing so as to reduce the storage volume within the bellows. Such an inwardly extending portion or may have a hat-shaped cross-section. The outer wall of the hat-shape has a radius r1 which is slightly less than the innermost radius r2 of the bellows. In one embodiment, the bellows is made at least in part, of plastic. In another embodiment, the bellows is made, at least in part, of a metal such as brass. In yet another embodiment, the bellows is made, at least in part, of copper. In another embodiment, the bellows is made, at least in part, of beryllium copper. In another embodiment, the bellows is made, at least in part, of a shape memory alloy. In another embodiment, the bellows is made, at least in part, of aluminum.

The bellows may optionally be coated, at least in part, with a brilliant coating such as gold or titanium nitride. Alternative, the bellows are electro-coated, at least in part, with a titanium nitride coating or a copper coating. Any portion of the bellows made of aluminum may be oxide coated in a variety of colors.

The piston shaft is large compared to the displacement distance delta L required to fully actuate the bellows (from position A to position Z). Further, given the thickness t of the material from which the bellows is made, a certain height h of the bellows is required and elastic expansion should be restricted in all directions but the control or actuation direction. Normally, one would be motivated to simply use a cap formed as the lower portion to seal both ends and of the bellows. However, if this is done, then a large volume of fluid would be contained in the bellows. A large volume of fluid then is subject to a larger amount of thermal expansion when the ambient temperature varies say between −10 and 50 degrees Celsius, which, when the fluid volume is used as an indication medium, results in large variations in the position of a meniscus particularly in a capillary tube. When such capillary tube is used to indicate time, for example, such variance results in a capillary indication system being unusable for indicating time, at least not with any accuracy during large temperature variations. The solution of the invention overcomes this problem by minimizing the volume of the fluid handled in such a system, while allowing for an interface with a larger actuator, thereby minimizing fluctuation of the position of the meniscus caused by temperature variation.

Referring now to FIG. 7, differing variants W, X, Y, and Z are shown. In variant W, immiscible fluid segments 1100, 1102 and 1104 are arranged such that the middle fluid 1102 is of a different and highly visible color (such as a florescent color) so as to produce two menisci, in order to provide a point-like indicator. In variant X, one fluid 1106, disposed between two other fluids 1110 and 1112, is a tritium ball. In variant Y, the tube of canal 706 has an interior surface of ground glass. The transparent segment 1106 allows the appearance of the index (<<10>> in this illustration) and is made up on a fluid immiscible with the other, with a refraction index which is matched to that of the substrate. In variant Z, an object 1120, such as a ball, is placed between the two nonmiscible fluids 1122 and 1124, which is now against the meniscus 801′.

In another embodiment, the invention is adapted to perform an injection and includes a standby, an insertion, an infusion and a retraction stage. In the standby stage, the needle is inside the device and the fluid reservoir is full, with the device held against the skin of the patient. In the insertion stage, the needle is inserted 1.5 mm to 2 mm beneath the skin into the intradermal skin layer. In the infusion stage, the fluidic channel is then opened and the reservoir begins to empty as the needle continues to travel to the 4 mm to 5 mm subcutaneous target depth. The needle is fixed within the reservoir septum and as it retracts, the reservoir/septum slide with it. The flow rate depends greatly on the reservoir design (material properties, geometry, etc.), size of the fluidic channel (needle inner diameter), and resistance beneath the skin. Once the reservoir begins to empty through a 27-31G (ultra-fine) needle, enough resistance is present to slow the spring travel so that the first bolus is thus delivered before the needle is retracted from the skin. Optionally, an indicator indicates whether the injection has been completed. It is important to provide feedback so the user knows the infusion process is complete and the device is ready for removal. Alternatively, a snap type interface can be implemented, so as the spring retracts, there is a “click” when the needle holder reaches the final position. A viewing window can be implemented as well, where a portion of the needle is flagged with a color, this portion moving behind a window, indicating that the needle holder has retracted.

Optionally, an adhesive may be applied to the base for retaining the dispensing device against a wearer's skin. In one embodiment, the adhesive is an adhesive pad fixedly attached to the base and having a protective sheet on an opposite face thereof which allows removal to expose the adhesive surface.

The flexible hollow membrane has a fluid (e.g. any fluid including those listed above) therein and is functionally disposed in the receiver.

In an embodiment, the trigger mechanism is controlled by a sensor or a wireless radio receiver by remote control. The control of speed of the injection may be made as a function of time by, for example, controlling a micro motor actuator which replaces in these embodiments, the function of the compression spring. Such motor (e.g. Squiggle) can be made such that it is part of a modular component which may be removably inserted into the device and removed for reuse, thus allowing the device to be made inexpensively, while permitting a more expensive actuation and control system. Such device may be illustrated by the unit in which the motor and electronics are integrated in the upper portion, while the dose and injection/retraction mechanism is located in the main housing.

In another embodiment, the device includes a second housing for housing the trigger mechanism. The second housing is releasably connectable to the main housing. It should be understood that both the invention can be used for extended bolus as well as by patients not capable of keeping the automatic injector steady against the injection site for the time required for conventional automatic injections (e.g., a few seconds). In an advantage, the invention provides a low-profile automatic injector or infusion device which is less likely to be inadvertently torn off the wearer, when such device is adhered to or held against the skin of a living organism using a holding device.

In another advantage, the invention provides a reliable and simple means of injecting a living organism. In another advantage, the invention provides for reliable self-injection.

In another advantage, the size of the device, as well as the fact that the mechanism is enclosed, render the device impossible to use a second time, thereby eliminating the risk of contamination of a second user or transmission of a disease of a first user to a second user. In another advantage, the fluid dispenser is suitable for being left on the living organism many hours, even days, available in the event that such is needed.

In another advantage, a fluid dispenser is provided whose profile is not, as a minimum, the depth of penetration of the needle used in the injection.

In another advantage, because the amount of active agent, drug or other fluid required to have its therapeutic effect is typically very small, preparations are currently typically highly diluted in order for the physician or nurse can see (via the scale on the needle reservoir circumference) the amount injected. Consequently, because the invention can inject the required amount of active ingredient for a typical treatment, the invention is adaptable to self-use and to sterile injections of essentially any therapeutic fluid for the treatment of many illnesses.

It should be appreciated that the particular implementations shown and described herein are representative of the invention and its best mode and are not intended to limit the scope of the present invention in any way. Furthermore, any connecting lines shown in the various figures contained herein are intended to represent exemplary functional relationships and/or physical couplings between various elements. It should be noted that many alternative or additional physical connections or functional relationships may be present and apparent to someone of ordinary skill in the field. Moreover, the apparatus, system and/or method contemplate the use, sale and/or distribution of any goods, services or information having similar functionality described herein.

The following and all International patent applications mentioned herein are incorporated by reference and relied upon as they show a fluid indicator in which a fluid meniscus is driven by a mechanism, and the references are fully incorporated herein as if fully set forth herein.

PCT Application No. PCT/IB2010/002054, filed 20 Aug. 2010, entitled FLUID INDICATOR;

PCT Application No. PCTAB2010/002055, filed 20 Aug. 2010, entitled VISUAL INDICATOR AND FLUID DISPENSER;

European Patent Application No. EP20100752595, filed 15 Sep. 2010, entitled WRISTWATCH;

PCT Application No. PCT/US2012/048044, filed 25 Jul. 2012, entitled FLUID DISPENSER;

PCT Application No. PCT/IB2012/002591, filed 5 Dec. 2012, entitled CAPILLARY FLOW CONTROL SYSTEM FOR FLUID INDICATOR;

PCT Application No. PCT/IB2012/002641, filed 10 Dec. 2012, entitled LOW to VOLUME PRECISION BELLOWS;

PCT Application No. PCT/IB2013/000659, filed 30 Jan. 2013, entitled INJECTION DEVICE USING DRY CARRIER;

PCT Application No. PCT/IB2013/000660, filed 12 Apr. 2013, entitled COMPENSATED CAPILLARY INDICATOR.

Other characteristics and modes of execution of the invention are described in the appended claims.

As used herein, the terms “comprises”, “comprising”, or any variation thereof, are intended to refer to a non-exclusive listing of elements, such that any process, method, article, composition or apparatus of the invention that comprises a list of elements does not include only those elements recited, but may also include other elements described in this specification. The use of the term “consisting” or “consisting of' or “consisting essentially of” is not intended to limit the scope of the invention to the enumerated elements named thereafter, unless otherwise indicated. Other combinations and/or modifications of the above-described elements, materials or structures used in the practice of the present invention may be varied or otherwise adapted by the skilled artisan to other design without departing from the general principles of the invention.

The specification and figures are to be considered in an illustrative manner, rather than a restrictive one and all modifications described herein are intended to be included within the scope of the invention claimed, even if such is not specifically claimed at the filing of the application. Accordingly, the scope of the invention should be determined by the claims appended hereto or later amended or added, and their legal equivalents rather than by merely the examples described above. For instance, steps recited in any method or process claims may be executed in any order and are not limited to the specific order to presented in any claim. Further, the elements and/or components recited in any apparatus claims may be assembled or otherwise operationally configured in a variety of permutations to produce substantially the same result as the present invention. Consequently, the invention is not limited to the specific configuration recited in the claims.

Further, the invention should be considered as comprising all possible combinations of every feature described in the instant specification, appended claims, and/or drawing figures which may be considered new, inventive and industrially applicable.

Multiple variations and modifications are possible in the embodiments of the invention described here. Although certain illustrative embodiments of the invention have been shown and described here, a wide range of modifications, changes, and substitutions is contemplated in the foregoing disclosure. For example, such indicators can be used as speed or RPM indicators in vehicles. Further, such indicators can be used to indicate body temperature or other parameters, like heart rate in sports, or in indicators used in medical devices or diagnostic equipment. While the above description contains many specifics, these should not be construed as limitations on the scope of the invention, but rather as exemplifications of one or another preferred embodiment thereof. In some instances, some features of the present invention may be employed without a corresponding use of the other features. In addition, the term “flexible” as used herein encompasses the concept of variable, in that a variable volume reservoir should be considered a flexible chamber, even if no individual components flex. Accordingly, it is appropriate that the foregoing description be construed broadly and understood as being given by way of illustration and example only, the spirit and scope of the invention being limited only by the claims which ultimately issue in this application.

It should be appreciated that the particular implementations shown and described herein are representative of the invention and its best mode and are not intended to limit the scope of the present invention in any way. Furthermore, the connecting lines shown in to the various figures contained herein are intended to represent exemplary functional relationships and/or physical couplings between various elements. It should be noted that many alternative or additional functional relationships or physical connections may be present in a practical system.

Moreover, the system contemplates the use, sale and/or distribution of any goods, services or information having similar functionality described herein.

Benefits, other advantages and solutions mentioned herein are not to be construed as critical, required or essential features or components of any or all the claims.

What is claimed is:

1. A device for providing an indication comprising:
a. an index,
b. a fluid channel or tube adjacent the index,
c. at least two nonmiscible liquids disposed in the fluid channel or tube
d. at least one bellows, and
e. a meniscus mobilizer controlled by a controller to displace a meniscus formed between the at least two liquids in the channel or tube to a desired location in relation to the index in order to indicate a value,
whereby controlled mobilization in both direction of the meniscus by the meniscus mobilizer is accomplished through the use of an electro-mechanical system adapted to expand and contract at least one bellows.

2. The device of claim 1 further comprising a temperature control sub-system, whereby the temperature control sub-system ensures reliable and accurate displacement velocity of the meniscus.

3. The device of claim 1, adapted to be mounted in a vehicle.

4. The device of claim 3, adapted to be mounted in transparent glass.

5. The device of claim 1 in which the indication is an indication of time.

6. The device of claim 1 wherein one of the two immiscible fluids is a fluorescent liquid on which the meniscus is formed adjacent the index.

7. The device of claim 6 further including an ultraviolet light generator adapted to illuminate the fluorescent fluid.

8. The device of claim 7 in which the ultraviolet light generator is an LED, whereby further the LED is disposed so as to avoid emitting light in a direction orthogonal to the viewer, thereby enabling the LED to be essentially invisible to the view such as a driver of a vehicle.

9. The device of claim 1, further limited as herein described in the instant application with reference to the instant specification and drawings, and further with reference to corresponding descriptions in applications and patents which have been herein incorporated by reference hereto.

10. A device for providing an indication comprising:
a. an index;
b. a fluid channel or tube adjacent the index;
c. at least two nonmiscible fluids disposed in the fluid channel or tube;
d. at least one bellows; and
e. a meniscus mobilizer controlled by a controller for displacing a meniscus formed between the at least two fluids in the channel or tube to a desired location in relation to the index in order to indicate a value,
whereby controlled mobilization in both direction of the meniscus by the meniscus mobilizer is accomplished through the use of at least a mechanical system adapted to expand and contract at least one bellows.

11. The device of claim 10, further limited as herein described in the instant application with reference to the instant specification and drawings, and further with reference to corresponding descriptions in applications and patents which have been herein incorporated by reference hereto.

12. A vehicle having integrated therein the device of claim 1.

13. A vehicle having integrated therein the device of claim 10.
